(19) United States
(12) Patent Application Publication
(10) Pub. No.: US 2006/0253997 A1
(43) Pub. Date: Nov. 16, 2006

(54) Method for making flame-retardant blended fabric using acrylic yarns

(76) Inventor: Yen-Liang Yin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/402,032

(22) Filed: Apr. 12, 2006

(30) Foreign Application Priority Data
May 13, 2005 (TW) 094115494

(51) Int. Cl. C11D 3/00

(52) U.S. Cl. 8/115.51

(57) ABSTRACT

Through the method of the present invention, a fabric with flame retardation is made with fewer steps of fabrication than is generally required. The method is a piece dyed section or a pre-dyed piece section. The fabric made is a blended fabric using acrylic yarns with a high ratio of natural cotton or feather. The fabric obtains humid-absorption, air-permeability, softness, hand feel and fitting.

### FIELD OF THE INVENTION

The present invention relates to methods for making a fabric; more particularly, relates to making a blended fabric with a great ratio of natural cotton or feather while obtaining humid-absorption, air-permeability, softness, hand feel and fitting with fewer steps of fabrication than is generally required.

### DESCRIPTION OF THE RELATED ART

A prior art, “A method for making a fireproof fabric”, is proclaimed in Taiwan, comprising steps of:

(a) Soaking a fabric in an aqueous solution containing a hydro-organic multi-phosphorus compound of hydroxyalkyl tetraphosphonate;

(b) Drying the soaked fabric to obtain a fabric with a remained moisture content between 13 percents (%) and 25%;

(c) Curing the dried fabric to obtain a cu red compound non-dissolvable to water, where the compound is fixed in the fibers of the fabric;

(d) Glazing the fabric for at least 1 hour before oxidization;

(e) Transforming a trivalent phosphate into a pentavalent phosphate by hydrogen peroxide through an oxidization of the cured compound; and

(f) Cleaning and drying the fabric.

Therein, in step (a), the compound is added to obtain a 50˜73% percents of the compound in the solution.

Although a fireproof fabric is obtained with the prior art, the procedure is complex. Besides, a fabric rich in cotton is comfortable; but it is hard to be fireproof except being processed with a post-finishing treatment. As a result, a fabric with fireproofing, humid-absorption and comfort at the same time is almost in lack, regard less of the urgent demands from people. Hence, the prior art does not fulfill users' requests on actual use.

### SUMMARY OF THE INVENTION

The main purpose of the present invention is to make a blended fabric with a high ratio of natural cotton or feather so that humid-absorption, air-permeability, softness, hand feel and fitting are obtained with fewer steps than is generally required while a flame retardation remains.

To achieve the above purpose, the present invention is a method for making a flame-retardant blended fabric using acrylic yarns, which is achieved through a piece dyed section or a pre-dyed piece section.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing the flow charts of the preferred embodiment according to the present invention;

FIG. 2 is a flow chart of the first part of the piece dyed section;

FIG. 3 is a flow chart of the first preferred embodiment of the first part of the pre-dyed piece

FIG. 4 is a flow chart for the second embodiment;

FIG. 5 is a flow chart of the second part of the piece dyed section and

FIG. 6 is a flow chart of the second part of the pre-dyed piece section.

### DESCRIPTION OF THE PREFERRED EMBODIMENT

The following description of the preferred embodiment is provided to understand the features and the structures of the present invention.

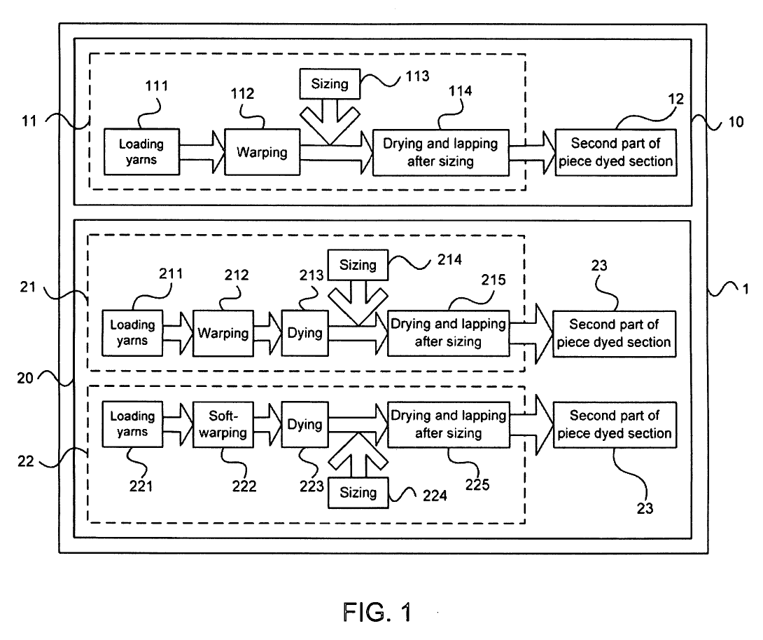

Please refer to FIG. 1, which is a view showing the flow charts of the preferred embodiment according to the present invention. As shown in the figure, the present invention is a method for making a flame-retardant blended fabric using acrylic yarns. The present invention makes a flame-retardant blended fabric using acrylic yarns through a procedure 1 of a piece dyed section 10 or a pre-dyed piece section 20, where the piece dyed section 10 comprises a first part of the piece dyed section 11 and a second part of the piece dyed section 12; and the pre-dyed piece section 20 comprises a first preferred embodiment 21 or a second embodiment 22 of a first part of the pre-dyed piece section and a second part of the pre-dyed piece section 23. The first part of the piece dyed section 11 comprises steps of loading yarns 111, warping 112, sizing 113, and drying and lapping after sizing 114. The first preferred embodiment of a first part of the pre-dyed piece section 21 comprises steps of loading yarns 211, warping 212, dying 213, sizing 214, and drying and lapping after sizing 215; and the second embodiment of the first part of the pre-dyed piece section 22 comprises steps of loading yarns 221, soft-warping 222, dying 223, sizing 224, and drying and lapping after sizing 225. Thus, with the above sections, a novel method for making a flame-retardant blended fabric using acrylic yarns is obtained.

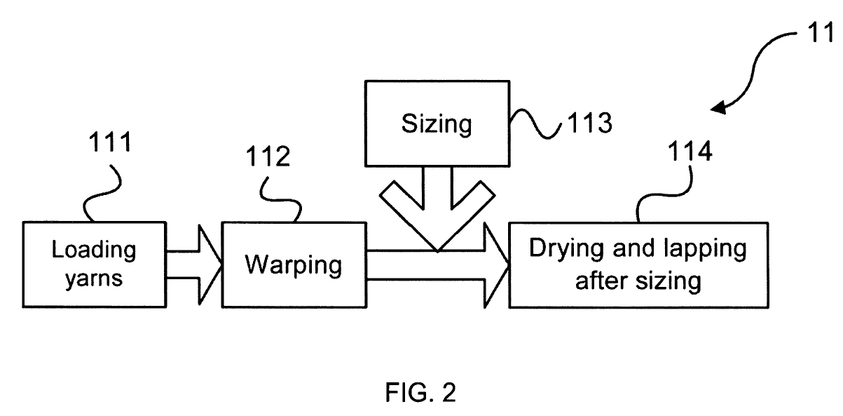

Please refer to FIG. 2, which is a flow chart of the first part of the piece dyed section. As shown in the figure, the first part of the piece dyed section 11 comprises the following steps:

(a) Loading yarns 111: Yarns containing acrylic yarns are loaded according to an order of a warping.

(b) Warping 112: The yarns are warped after cleaning a warping machine at a speed of 200˜500 meters (m) per minutes (min) to obtain a blended fabric with a stiffness of 60˜80 percents (%), where a tension is set according to a number of yarn counts; leas, broken yarns and flyers are controlled; and the required quality for the blended fabric is obtained.

(c) Sizing 113: The blended fabric is sized according to a standard sizing procedure, comprising steps of:
(i) feeding a material having a ratio of polymerized vinyl acrylic (PVA) to starch from 80-to-20 to 20-to-80 according to a feeding order;
(ii) stirring the material for 20 min under a raising temperature until 60 Celsius degrees (° C.) and then transferring the material to a high-pressure bucket;
(iii) raising the temperature to 120° C. in a rate of 1˜3 Celsius degrees per minute (° C./min);
(iv) retaining the temperature for 10˜30 min;
(v) transferring the material to a sizing tank and examining a sized amount of the blended fabric; and
(vi) lowering the temperature naturally to 70˜80° C. and examining a density and viscosity of the material.

(d) Drying and lapping after sizing 114: After being sized, the blended fabric is dried and lapped under a temperature of 60˜90° C. for the sizing tank, a temperature of 95˜125° C. for a hot drying, a speed of 30˜80 meters per minute (m/min) for processing, an adjusted grinding pressure according to numbers of yarn counts and warps, a stiffness of 65˜85% for the blended fabric, and a moisture content of 4˜8% for the blended fabric.

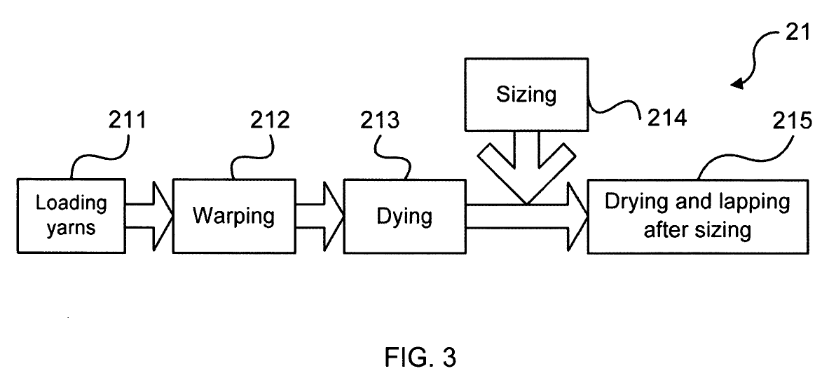

Please refer to FIG. 3, which is a flow chart of the first preferred embodiment of the first part of the pre-dyed piece section. As shown in the figure, the first preferred embodiment of the first part of the pre-dyed piece section 21 comprises the following steps:

(a) Loading yarns 211: Yarns containing acrylic yarns are loaded according to an order of a warping;

(b) Warping 212: After cleaning a warping machine, the yarns are warped at a speed of 200˜500 m/min to obtain a blended fabric with a stiffness of 60˜80%, where a tension is set according to a number of yarn counts; leas, broken yarns and flyers are controlled; and the required quality for the blended fabric is obtained.

(c) Dyeing 213: The blended fabric is dyed with a dyeing auxiliary under a temperature raised at a rate of 1˜3° C./min, a temperature of 98° C. for dyeing retained for 10˜30 min, and a temperature lowered down to 65° C. at a rate of 1˜3° C./min.

(d) Sizing 214: The blended fabric is sized according to a standard sizing procedure, comprising steps of:
(i) feeding a material having a ratio of PVA to starch from 80-to-20 to 20-to-80 according to a feeding order;
(ii) stirring the material for 20 min under a raising temperature until 60° C. and then transferring the material to a high-pressure bucket;
(iii) raising the temperature to 120° C. in a rate of 1˜3° C./min;
(iv) retaining the temperature for 10˜30 min;
(v) transferring the material to a sizing tank and examining an amount of the sized blended fabric and
(vi) lowering the temperature naturally to 70˜80° C. and examining a density and viscosity of the material; and

(e) Drying and lapping after sizing 215: After being sized, the blended fabric is dried and lapped under a temperature of 60˜90° C. for the sizing tank, a temperature of 95˜125° C. for a hot drying, a speed of 30˜80 m/min for processing, an adjusted grinding pressure according to numbers of yarn counts and warps, a stiffness of 60˜85% for the blended fabric, and a moisture content of 4˜8% in the blended fabric.

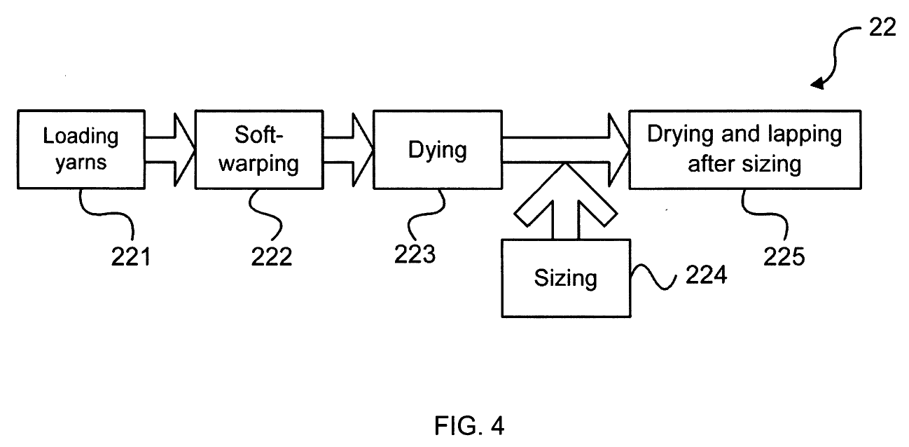

Please refer to FIG. 4, which is a flow chart of the second embodiment of the first part of the pre-dyed piece section. As shown in the figure, the second embodiment of the first part of the pre-dyed piece section 22 comprises the following steps:

(a) Loading yarns 221: Yarns containing acrylic yarns are loaded according to an order of a warping.

(b) Soft-warping 222: After cleaning a warping machine, the yarns are warped at a slow speed to obtain a blended fabric under control with tension parts according to a count number of the yarns and a stiffness of 50˜60% for the blended fabric, where flyers are prevented; joint-head sizes for broken yarns are monitored; and qualities are under control.

(c) Dyeing 223: The blended fabric is dyed with a dyeing auxiliary under a temperature raised at a rate of 1˜3° C./min, a temperature of 98° C. retained 10˜30 min for dyeing, and a temperature lowered down to 65° C. at a rate of 1˜3° C./min.

(d) Sizing 224: The blended fabric is sized according to a standard sizing procedure, comprising steps of:
(i) feeding a material having a ratio of PVA to starch from 80-to-20 to 20-to-80 according to a feeding order;
(ii) stirring the material for 20 min under a raising temperature until 60° C. and then transferring the material to a high-pressure bucket;
(iii) raising the temperature to 120° C. in a rate of 1˜3° C./min;
(iv) retaining the temperature for 10˜30 min;
(v) transferring the material to a sizing tank and examining an amount of the sized blended fabric; and
(vi) lowering the temperature naturally to 70˜80° C. and examining a density and viscosity of the material; and

(e) Drying and lapping after sizing 225: After being sized, the blended fabric is dried and lapped under a temperature of 60˜90° C. for the sizing tank, a temperature of 95˜125° C. for a hot drying, a speed of 30˜80 m/min for processing, an adjusted grinding pressure according to numbers of yarn counts and warps, a stiffness of 60˜85% for the blended fabric, and a moisture content of 4˜8% in the blended fabric.

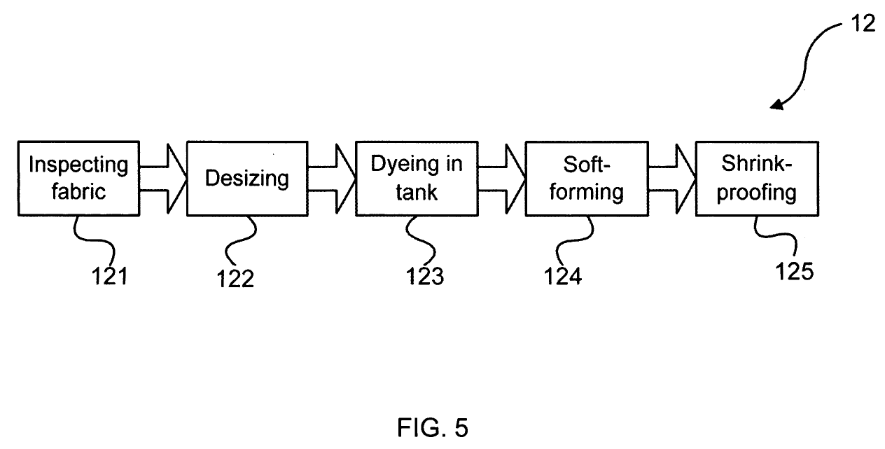

Please refer to FIG. 5, which is a flow chart of the second part of the piece dyed section. As shown in the figure, the second part of the piece dyed section 12 comprises the following steps:

(a) Inspecting fabric 121: The blended fabric is examined according to structural specifications of a fabric width, a design board and a side quality.

(b) Desizing 122: After removing long hair feathers by a singeing beforehand to prevent the blended fabric from pilling, the blended fabric is desized with an agent having a prescription of an enzyme of 100 kilograms per kilolitre (kg/kL) and an L300 of 30 kg/kL under a speed of 15˜100 m/min for processing, a temperature of 50˜80° C. for a tank and a time period of 20˜60 min for reaction, where percents of remaining liquor, tensile strength, tear strength, whiteness, fabric width and pH value are tested and measured.

(c) Dyeing in tank 123: According to a requirement to obtain a dichroism of two sides with a fabric width, the blended fabric is dyed in the tank under a raising temperature for the tank at a rate of 1˜3° C./min, a retaining of the temperature under 95° C. for 20˜70 min, a dropping of the temperature until 50˜80° C. at a rate of 1˜3° C./min, a pH value of 4˜7, and an adding of color liquor by dosing.

(d) Soft-forming 124: The blended fabric is formed softly with a pre-drying under a temperature of 105˜140° C. for 10˜60 seconds (sec) and a hot drying under a temperature of 110˜170° C., where the agent for soft-forming is determined according to hand feel; the shrinkage rate is smaller than 10%; and the quality of the sides and the material is obtained.

(e) Shrink-proofing 125: The blended fabric is shrink-proofed by using a rubber tube and a hot-drying tube after the soft-forming through a hot drying under a pressure of 1˜4 kilograms per square centimeter (kg/cm²) for the rubber tube, a pressure of 1.5˜6 kg/cm² for the hot-drying tube, a rotating velocity of 15˜60 m/min, and a remaining shrinkage rate below 10%.

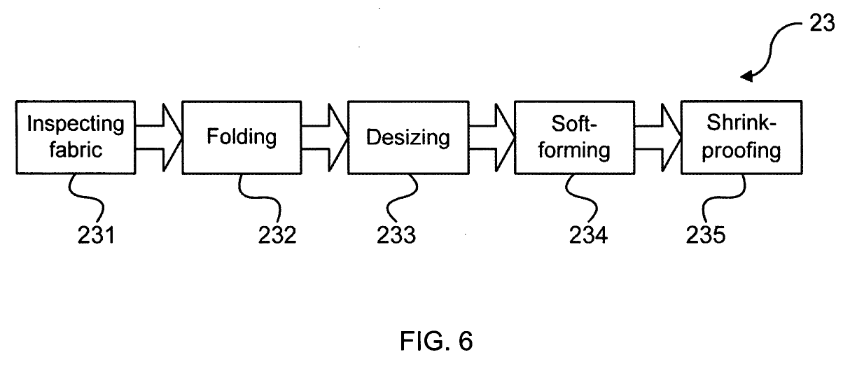

Please refer to FIG. 6, which is a flow chart of the second part of the pre-dyed piece section. As shown in the figure, the second part of the pre-dyed piece section 23 comprises the following steps:

(a) Inspecting fabric 231: The blended fabric is examined according to structural specifications of a fabric width, a design board and a side quality.

b) Folding 232: After confirming a design number, a right side and a wrong side for the blended fabric, selvedges of the blended fabric are torn for an overlock to be folded.

(c) Desizing 233: After removing long hair feathers by a singeing beforehand to prevent the blended fabric from pilling, the blended fabric is desized at a rate of 30˜100 m/min with an agent having a prescription of an enzyme of 40˜100 kg/kL and an osmotic agent of 10˜50 kg/kL with a remaining liquor below 4%, a humid-absorption in 1 min and a pressure of 1˜3 kg/cm² for a hot-drying cylinder. The blended fabric is desized under a speed of 30˜100 m/min for processing, 10 desizing tanks for processing, a temperature of 50˜80° C. for first 5 of the desizing tanks, a temperature of 60˜90° C. for the other 5 of the desizing tanks, and a temperature of 50˜90° C. for the tank containing the agent.

(d) Soft-forming 234: The blended fabric is formed softly to obtain a softness below 6% and a remaining shrinkage rate below 10% through a pre-drying under a temperature of 105˜140° C. for 10˜60 sec and a hot drying under a temperature of 110˜150° C., where the ionization is monitored; the agent for softening is changed according to the hand feel, and the shrinkage rate is below 10%.

(e) Shrink-proofing 235: By using a rubber tube and a hot-drying tube after the soft-forming through a hot drying, the blended fabric is shrink-proofed under a pressure of 1˜4 kg/cm² for the rubber tube, a pressure of 4.5 kg/cm² for the hot-drying tube, a rotating velocity of 15˜60 m/min, and a remaining shrinkage rate below 10%.

To sum up, the present invention is a method for making a flame-retardant blended fabric using acrylic yarns, where a blended fabric with a high ratio of natural cotton or feather obtains humid-absorption, air-permeability, softness, hand feel and fitting while obtaining flame retardation with fewer steps of fabrication than is generally required.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method for making a flame-retardant blended fabric using acrylic yarns, a method of a piece dyed section, comprising steps of:
(a) loading yarns containing acrylic yarns according to an order of a warping;
(b) warping said yarns at a speed of 200˜500 meters (m) per minutes (min) to obtain a blended fabric with a stiffness of 60˜80 percents (%);
(c) sizing said blended fabric according to a standard sizing procedure, comprising steps of:
(i) feeding a material having a ratio of polymerized vinyl acrylic (PVA) to starch from 80-to-20 to 20-to-80 according to a feeding order;
(ii) stirring said material under a raising temperature and then transferring said material to a high-pressure bucket;
(iii) raising said temperature to 120 Celsius degrees (° C.) in a rate of 1˜3 Celsius degrees per minute (° C./min);
(iv) retaining said temperature for 10˜30 min;
(v) transferring said material to a sizing tank and examining a sized amount of said blended fabric; and
(vi) lowering said temperature naturally to 70˜80° C. and examining a density and viscosity of said material; and
(d) drying and lapping said blended fabric after said sizing under conditions of:
(i) a temperature of 60˜90° C. for said sizing tank;
(ii) a temperature of 95˜125° C. for a hot drying;
(iii) a speed of 30˜80 meters per minute (m/min) for processing;
(iv) an adjusted grinding pressure according to a number of yarn counts and a number of warps;
(v) a stiffness of 65˜85% for said blended fabric; and
(vi) a moisture content of 4˜8% in said blended fabric.

2. The method according to claim 1,
wherein said piece dyed section further comprises steps of:
(a) examining said blended fabric according to structural specifications of a fabric width, a design board and a side quality;
(b) under conditions of a speed of 15˜100 m/min for processing, a temperature of 50˜80° C. for a tank and a time period of 20˜60 min for reaction after removing long hair feathers by a singeing beforehand to prevent said blended fabric from pilling, desizing said blended fabric with an agent having a prescription of an enzyme of 100 kilograms per kilolitre (kg/kL) and an L300 of 30 kg/kL;
(c) dyeing said blended fabric in said tank according to a requirement to obtain a dichroism of two sides with a fabric width under conditions of:
(i) a rising of a temperature at a rate of 1˜3° C./min for said tank;
(ii) a retaining of said temperature under 95° C. for 20˜70 min;
(iii) a dropping of said temperature at a rate of 1˜3° C./min until 50˜80° C.;
(iv) a pH value of 4˜7; and
(v) an adding of color liquor by dosing;
(d) soft-forming with a pre-drying under a temperature of 105˜140° C. for 10˜60 seconds (sec) and a hot drying under a temperature of 110˜170° C.; and
(e) shrink-proofing by using a rubber tube and a hot-drying tube after said soft-forming through a hot drying under conditions of:
(i) a pressure of 1˜4 kilograms per square centimeter (kg/cm²) for said rubber tube;
(ii) a pressure of 1.5˜6 kg/cm² for said hot-drying tube;
(iii) a rotating velocity of 15˜60 m/min; and
(iv) a remaining shrinkage rate below 10%.

3. A method for making a flame-retardant blended fabric using acrylic yarns, a method of a pre-dyed piece section, comprising steps of:
(a) loading yarns containing acrylic yarns according to an order of a warping;
(b) after cleaning a warping machine, warping said yarns at a speed of 200˜500 m/min to obtain a blended fabric with a stiffness of 60˜80%;
(c) dyeing said blended fabric with a dyeing auxiliary under conditions of a temperature being raised at a rate of 1˜3° C./min, a temperature of 98° C. for dyeing being retained for 10˜30 min, and a temperature being lowered down to 65° C. at a rate of 1˜3° C./min;
(d) sizing said blended fabric according to a standard sizing procedure, comprising steps of:
(i) feeding a material having a ratio of PVA to starch from 80-to-20 to 20-to-80 according to a feeding order;
(ii) stirring said material under a raising temperature until 60° C. and then transferring said material to a high-pressure bucket;
(iii) raising said temperature to 120° C. in a rate of 1˜3° C./min;
(iv) retaining said temperature for 10˜30 min;
(v) transferring said material to a sizing tank and examining a sized amount of said blended fabric; and
(vi) lowering said temperature naturally to 70˜80° C. and examining a density and viscosity of said material; and
(e) drying and lap ping said blended fabric after said sizing under conditions of:
(i) a temperature of 60˜90° C. for said sizing tank;
(ii) a temperature of 95˜125° C. for a hot drying;
(iii) a speed of 30˜80 m/min for processing;
(iv) an adjusted grinding pressure according to a number of yarn counts and a number of warps;
(v) a stiffness of 60˜85% for said blended fabric; and
(vi) a moisture content of 4˜8% in said blended fabric.

4. The method according to claim 3,
wherein said pre-dyed piece section further comprises steps of:
(a) examining said blended fabric according to structural specifications of a fabric width, a design board and a side quality;
(b) after confirming a design number, a right side and a wrong side for said blended fabric, tearing selvedges of said blended fabric for an overlock to be folded;
(c) under conditions of a speed of 30˜100 m/min for processing, 10 desizing tanks for processing, a temperature of 50˜80° C. for first 5 desizing tanks in said 10 desizing tanks, a temperature of 60˜90° C. for the other 5 desizing tanks in said 10 desizing tanks, and a temperature of 50˜90° C. for said tank containing said agent, desizing said blended fabric with an agent having a prescription of an enzyme of 40˜100 kg/kL and an osmotic agent of 10˜50 kg/kL under after removing long hair feathers by a singeing beforehand to prevent said blended fabric from pilling while having a remaining liquor below 4%, a humid-absorption in 1 min and a pressure of 1˜3 kg/cm² for a hot-drying cylinder;
(d) through a pre-drying under a temperature of 105˜140° C. for 10˜60 sec and a hot drying under a temperature of 110˜150° C., soft-forming to obtain a softness below 6% and a remaining shrinkage rate below 10%; and
(e) after said soft-forming through a hot drying, shrink-proofing by using a rubber tube and a hot-drying tube under conditions of:
i) a pressure of 1˜4 kg/cm² for said rubber tube;
(ii) a pressure of 4.5 kg/cm² for said hot-drying tube;
(iii) a rotating velocity of 15˜60 m/min; and
(iv) a remaining shrinkage rate below 10%.

5. A method for making a flame-retardant blended fabric using acrylic yarns, a method of a pre-dyed piece section, comprising steps of:
(a) loading yarns according to an order of a warping;
(b) after cleaning a warping machine, warping said yarns at a slow speed to obtain a blended fabric under control with tension parts according to a count number of said yarns and a stiffness of 50˜60% for said blended fabric obtained;
(c) dyeing said blended fabric with a dyeing auxiliary under conditions of a temperature being raised at a rate of 1˜3° C./min, a temperature of 98° C. for dyeing being retained for 10˜30 min, and a temperature being lowered down to 65° C. at a rate of 1˜3° C./min;
(d) sizing said blended fabric according to a standard sizing procedure, comprising steps of:
(i) feeding a material having a ratio of PVA to starch from 80-to-20 to 20-to-80 according to a feeding order;
(ii) stirring said material under a raising temperature until 60° C. and then transferring said material to a high-pressure bucket;
(iii) raising said working temperature to 120° C. in a rate of 1˜3° C./min;
(iv) retaining said temperature for 10˜30 min;
(v) transferring said material to a sizing tank and examining a sized amount of said blended fabric; and
(vi) lowering said temperature naturally to 70˜80° C. and examining a density and viscosity of said material; and
(e) drying and lapping said blended fabric after said sizing under conditions of:
(i) a temperature of 60˜90° C. for said sizing tank;
(ii) a temperature of 95˜125° C. for a hot drying;
(iii) a speed of 30˜80 nm/min for processing;
(iv) an adjusted grinding pressure according to a number of yarn counts and a number of warps;
(v) a stiffness of 60˜85% for said blended fabric; and
(vi) a moisture content of 4˜8% in said blended fabric.

6. The method according to claim 3,
wherein said pre-dyed piece section further comprises steps of:
(a) examining said blended fabric according to structural specifications of a fabric width, a design board and a side quality;
(b) after confirming a design number, a right side and a wrong side for said blended fabric, tearing selvedges of said blended fabric for an overlock to be folded;
(c) under conditions of a speed of 30˜100 m/min for processing, 10 desizing tanks for processing, a temperature of 50˜80° C. for first 5 desizing tanks in said 10 desizing tanks, a temperature of 60˜90° C. for the other 5 desizing tanks in said 10 desizing tanks, and a temperature of 50˜90° C. for a tank containing said agent, desizing said blended fabric at a rate of 30˜100 m/min with an agent having a prescription of an enzyme of 40˜100 kg/kL and an osmotic agent of 10˜50 kg/kL after removing long hair feathers by a singeing beforehand to prevent said blended fabric from pilling while having a remaining liquor below 4%, a humid-absorption in 1 min and a pressure of 1˜3 kg/cm² for a hot-drying cylinder;
(d) soft-forming to obtain a softness below 6% and a remaining shrinkage rate below 10% through a pre-drying under a temperature of 105˜140° C. for 10˜60 sec and a hot drying under a temperature of 110˜150° C.; and
(e) shrink-proofing by using a rubber tube and a hot-drying tube after said soft-forming through a hot drying under conditions of:
(i) a pressure of 1˜4 kg/cm² for said rubber tube;
(ii) a pressure of 4.5 kg/cm² for said hot-drying tube;
(iii) a rotating velocity of 15˜60 m/min; and
(iv) a remaining shrinkage rate below 10%.
